(19) United States
(12) Patent Application Publication
(10) Pub. No.: US 2009/0180440 A1
(43) Pub. Date: Jul. 16, 2009

(54) Client-Based Multimode Handover in Communication Systems

(75) Inventors: Chaitali Sengupta, Richardson, TX (US); Yuan Kang Lee, San Diego, CA (US); Naveen Makineni, Richardson, TX (US); Sudipta Sen, Richardson, TX (US); Suresh Srinivasan, Dallas, TX (US)

Correspondence Address: HAYNES AND BOONE, LLP;IP Section, 2323 Victory Avenue, Suite 700, Dallas, TX, 75219, US

(73) Assignee: SNRLabs Corporation, Richardson, TX (US)

(21) Appl. No.: 12/354,640

(22) Filed: Jan. 15, 2009

Related U.S. Application Data
(60) Provisional application No. 61/021,569, filed on Jan. 16, 2008.

(51) Int. Cl. H04W 36/00

(52) U.S. Cl. 370/331

(57) ABSTRACT

A communication system having a first communication device being in communication with a second communication device via a communication connectivity to a first communication network. The first communication device having a first handover module operable to handover communication connectivity from the first communication network to a second communication network. The second communication device having a second handover module cooperatively operable with the first handover module to maintain communication between the second communication device and the first communication device while the first handover module operates to handover communication connectivity from the first communication network to the second communication network.

### RELATED APPLICATIONS

This application claims the benefit of U.S. Provisional Application No. 61/021,569 filed Jan. 16, 2008 entitled “Client-Based Multimode Handover (HO) in Communication Systems,” the disclosures of which is entirely incorporated herein by reference.

This application is related to co-pending U.S. patent application Ser. No. 11/929,231, filed Oct. 30, 2007, entitled “System, Method, and Computer-Readable Medium for User Equipment Decision-Making Criteria for Connectivity and Handover,” and to U.S. patent application Ser. No. 11/929,066, filed Oct. 30, 2007, entitled “System, Method, and Computer-Readable Medium for Selecting a Network for Connectivity and Handover Based on Application Requirements,” the disclosures of which are incorporated by reference.

### BACKGROUND

Recently there has been a surge of communication devices in the marketplace that have multimode capabilities. These multimode communication devices are capable of communicating via dual radio connections with various communication networks that may be employing different communication protocols. For example, typical multimode communication devices are capable of communicating with various type of networks such as cellular networks (e.g. Global System for Mobile communication (GSM), General Packet Radio Service (GPRS), Code Division Multiple Access (CDMA), Third Generation (3G), etc) and wireless broadband (e.g. Wireless Fidelity (WiFi), Worldwide Interoperability for Microwave Access (WiMAX), Long Term Evolution (LTE), Femtocells, etc). Today a typical multimode communication device may communicate via one radio communication path to a cellular network employing a circuit-switched or packet-switched topology, and via the other radio communication path to a wireless broadband network employing a packet-switched network topology.

### SUMMARY OF THE INVENTION

A communication system having a first communication device being in communication with a second communication device via a communication connectivity to a first communication network. The first communication device having a first handover module operable to handover communication connectivity from the first communication network to a second communication network. The second communication device having a second handover module cooperatively operable with the first handover module to maintain communication between the second communication device and the first communication device while the first handover module operates to handover communication connectivity from the first communication network to the second communication network.

A method of handover including establishing a first communication path between a local communication device and a remote communication device via a first network connection of the local communication device. Additionally, the method comprises communicating a first message having an identity information from the local communication device to the remote communication device via the first communication path, wherein the remote communication device confirms receipt of the identity information. Furthermore, the method includes forming a second network connection at the local communication device and sending a second message having the identity information via the second network connection to the remote communication device. Also, the method includes establishing a second communication path between the local communication device and the remote communication device via the second network connection at the local communication device in response to receiving the second message. Finally, the method comprises terminating the first communication path.

A method for a client-based handover process including establishing a first communication path between a local communication device and a remote communication device via a first network connection of the local communication device. The method further comprising sending, by the local communication device, a first message having an identifying information of the first communication device across the first network connection to the remote communication device. Additionally, the method includes determining, by the local communication device, to form a second communication path between the local communication device and the remote communication device by utilizing a second network connection of the local communication device. Also, the method comprises sending, by the local communication device, a second message having the identifying information across the second network connection of the local communication device. Furthermore, the method includes establishing the second communication path between the local communication device and the remote communication device via the second network connection of the local communication device. Finally, the method comprises terminating the first communication path.

A method for a client-based handover process including establishing a first communication path between a remote communication device and a local communication device via a first network connection of the local communication device. The method further comprises receiving, by the remote communication device, a first message having an identifying information of the first communication device, the first message being received from the first network connection. Additionally, the method includes receiving, by the remote communication device, a second message having the identifying information, the second message being received from the second network connection. Furthermore, the method includes establishing a second communication path between the local communication device and the remote communication device utilizing the second network connection of the local communication device. Finally, the method comprises terminating the first communication path.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level network diagram of an exemplary environment in which a client-based multimode handover system may operate.

FIG. 2 is a network diagram of an exemplary environment in which the client-based multimode handover process may operate.

FIG. 3 is a network diagram of an exemplary environment in which the client-based multimode handover process may operate.

FIG. 4 is a network diagram of an exemplary environment in which the client-based multimode handover process may operate.

FIG. 5 is a network diagram of an exemplary environment in which the client-based multimode handover process may operate.

FIG. 6 is a network diagram of an exemplary environment in which the client-based multimode handover process may operate.

FIG. 7 is a network diagram of an exemplary environment in which the client-based multimode handover process may operate.

FIG. 8 is a network diagram of an exemplary environment in which the client-based multimode handover process may operate.

FIG. 9 is a network diagram of an exemplary environment in which the client-based multimode handover process may operate.

FIG. 10 is a network diagram of an exemplary environment in which the client-based multimode handover process may operate.

FIG. 11 is a data flow diagram of an exemplary embodiment of the client-based multimode handover process occurring between local device 100 and remote device 102.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

Today, a multimode communication device can separately make a call using either of the device's one or more radio connections to a network such as a cellular or wireless broadband network. However, because these cellular and wireless broadband networks are separately owned and do not operate in a coordinated fashion, the multimode communication device cannot maintain call continuity when the device attempts to switch a call from the cellular network connection to the wireless broadband network connection, or vice versa.

Currently, the resolution of this problem relies on network providers to enable a multimode communication device to switch a call from one network to another network. Presently, in order for a multimode communication device to maintain call continuity when switching from one network to another network, the two networks have to be converged. That is, the device's network provider has installed network equipment and accompanying network-based software that enable network convergence such that the networks appear to a multimode communication device as a single network.

Currently, as an example, network providers are converging their various networks using IMS (IP Multimedia Subsystem) as a standard. A network service provider who has implemented an IMS-converged network has the ability to allow a multimode communication device to use equipment within the network as an anchoring point to handover the user's call from one network to another while maintaining call continuity. Thus, an IMS-converged network is required to maintain call continuity while switching a call between the network provider's various networks.

However, there are many problems associated with relying on an IMS-converged network to maintain call continuity when using a multimode communication device. One shortcoming is that the users of the multimode communication devices have to rely on their network service providers to provide an IMS-converged network. A further shortcoming is that this service is not widely available today, as such an IMS-converged network is still under development.

To address these problems, the following description enables one skilled in the art to utilize a client-based multimode handover scheme. By using client-based multimode handover described herein, multimode handover is possible without requiring the provision of an IMS-converged network. Accordingly, multimode communication device users are free to subscribe to services offered by network providers that do not provide a converged network.

In general, two aspects are considered for the client-based handover process. The first is for the multimode communication device to have access, either wired or wireless, to two or more connections that allow the device to connect to various networks. The second is an anchoring point that does not require alterations to the network provider's networks and supports the handover of a call associated with the multimode communication device from one network to another network while maintaining call continuity.

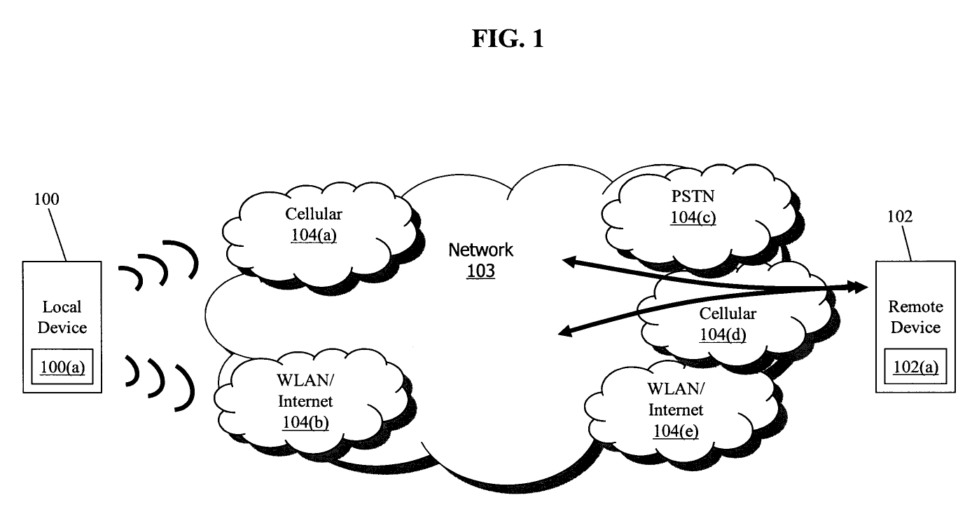

FIG. 1 is a high-level network diagram of an exemplary environment in which a client-based multimode handover system may operate. A local deice 100 is shown in communication with a remote device 102 over a network 103. Local device 100 represents a multimode communication device that will execute a handover from one radio network to another radio network while maintaining call continuity. Local device 100 can be, for example, a multimode communication device that is capable of making calls utilizing various networks (i.e. cellular or wireless broadband, circuit-switched or packet-switched). As shown, local device 100 may connect to a first network, for example, a cellular network 104(a) and a second network, for example, a Wireless Local Area Network (WLAN) 104(b) that is coupled to the Internet. Although local device 100 is shown in FIG. 1 as being connected to cellular network 104(a) and WLAN 104(b), local device 100 can be connected to any communication network based on any communication protocol. How local device 100 gets access to any network including, but not limited to cellular network 104a and WLAN/104b, can be either directly (wired or wireless) or via a short-distance-wireless (SDW) technology such as Bluetooth.

It should be noted that although local device 100 is described above as simply a multimode communication device, local device 100 can be any communication device as long as local device 100 has at least two separate means for connecting to various networks. The at least two connections to the various networks can be either wired or wireless (e.g., radio) or one of each. Furthermore, the connections to the networks can be accessible either directly or indirectly (e.g., through an intermediate device) from local device 100.

As an example, local device 100 can be any number of devices including, but not limited to cellular telephones, smartphones, and personal digital assistants having multiple radio transceivers allowing access to multiple networks such as GSM, 3G, EDGE (Enhanced Data rates for Global Evolution), and Internet networks. Additionally, for example, local device 100 can be a computer such as a desktop, laptop, and/or netbook having access to various networks through multiple wired or wireless connections. The examples identified above are not considered an exhaustive listing, but instead is presented to demonstrate that any device capable of accessing various networks via wired or wireless connections can implement the client-based multimode handover method described herein.

Local device 100 may also be a combination of two or more devices that together provide the end user multiple wired or wireless connections to various networks. For example, local device 100 may be a combination of a voice over Internet Protocol (VoIP) software module, such as SKYPE, residing on a computer having access to the Internet to allow VoIP calls and a GSM phone providing access to a GSM network. The GSM phone and the computer running the VoIP software may be connected to one another via a cellular headset. Thus, the combination of the computer with VoIP and the GSM phone may operate as local device 100 because the combination allows more than one connection to various networks.

Similarly, local device 100 may include a single-mode device such as a personal digital assistant (PDA). The PDA may have WiFi capability that enables the PDA to access a wireless Internet connection. Additionally, the PDA may have Bluetooth connectivity that enables the PDA to connect to another Bluetooth-enabled device such as a cellular device. Accordingly, the PDA has access to two separate network connections, namely, one connection providing access to the Internet and the other connection providing access to the cellular network. Thus, a single-mode device such as a PDA may operate as local device 100.

Accordingly, local device 100 may comprise any of the following devices such as a soft phone (e.g., VoIP software module) on a personal computer, cell phone, session initiated protocol (SIP) phone, VoIP phone, Bluetooth device enabled to communicate with a phone, personal digital assistant, WiFi-enabled phone, and a phone operable on a public switched telephone network (PSTN). As previously mentioned, the above is not an exhaustive listing, but instead is presented to demonstrate that any communication device capable of accessing various networks via more than one connection may operate as local device 100 when implemented according to the teachings herein.

Additionally shown in FIG. 1 is a remote device 102. Remote device 102 represents a second communication device in communication with local device 100. The description and examples set forth above associated with local device 100 are equally applicable to remote device 102. However, remote device 102 can be a single-mode or multimode communication device with the ability to communicate with a circuit-switched, packet-switched, cellular, wireless broadband, wireless, or wire-line network. As shown in FIG. 1, remote device 102 has access to cellular network 104(d). However, the remote device may be a different type of device, having instead access to a PSTN 104(c) or a WLAN/IP network 104(e).

Although cellular network 104(a) and cellular network 104(d) are shown in FIG. 1 as two separate cellular networks, it is within the scope of this disclosure that cellular networks 104(a) and 104(d) are the same network. Likewise, even though WLAN/IP 104(b) and WLAN/IP 104(e) are shown as separate networks, it is within the scope of this disclosure that these two networks are the same network. Accordingly, local device 100 and remote device 102 may be connected via the same or different network service providers and/or networks.

Details of the client-based multimode handover process is described below. Local device 100, includes a handover engine module 100(a) to perform client-based multimode handover. Handover engine module 100(a) is responsible for initiating the handover decision and is implemented by a software and/or hardware module residing in local device 100.

Remote device 102 includes a handover anchor module 102(a) that enables remote device 102 in combination with its network provider to act as an anchoring point to allow local device 100 to switch from a connection to a first network to a connection to a second network while maintaining communication with remote device 102. Accordingly, handover anchor module 102 utilizes the network servicing remote device 102 as a means to enable client-based multimode handovers.

It should be noted, that the client-based multimode handover process does not require that the network provider of either local device 100 and/or remote device 102 to explicitly support client-based multimode handovers. In that regard, no hardware and/or software modules need to be implemented by the network provider servicing either local device 100 or remote device 102 in order for the respective network providers to support client-based multimode handovers. Instead, the client-based handover process described herein utilizes the existing network providers' topologies in combination with handover engine module 100(a) of local device 100 and handover anchor module 102(a) of remote device 102 to perform client-based multimode handovers. Thus, the client-based multimode handover is performed independent of any specific network topology and transparent to the network provider servicing local device 100 and remote device 102, respectively.

Similar to handover engine module 100(a), handover anchor module 102(a) is implemented by a software and/or hardware module residing in remote device 102. The implementation of the handover engine and anchor module may be based on any embedded software operating system or on any high-level operating system that may be running on local device 100 and remote device 102. For example, the embedded software operating system and/or high-level operating system may include, but not limited to WINDOWS MOBILE, SYMBIAN, PALM OS, LINUX, APPLE OS, and GOOGLE OS.

As an example with respect to FIG. 1, local device 100 makes a first call to remote device 102 over cellular network 104(a). It should be noted that the term “call” is intended to be broadly construed to include, for example, voice, email, data, video, messaging, file transfer, and web sessions. Utilizing client-based multimode handover, when local device 100 decides to switch the call from a cellular network 104(a) connection to a WLAN/Internet network 104(b) connection, handover engine module 100(a) of local device 100 makes a second call to remote device 102 via WLAN/internet network 104(b) connection. Using a call waiting service capability of remote device 102, for example, handover anchor module 102(a) within remote device 102 recognizes that local device 100 is calling via another network. Remote device 102 under the control of its handover anchor module 102(a) then switches to the second call and disconnects the first call, effectively completing the client-based multimode handover process. In effect, local device 100 “anchors” the first and second calls on remote device 102 and its communication network or service provider.

In the scenario described above and hereinafter, either local device 100 or remote device 102 may originate the first call, and local or remote device may originate the second call for the purposes of the client-based multimode handover process. It is contemplated herein that both local device 100 and remote device 102 may include both handover engine and anchor modules so that either device may decide to perform a client-based multimode handover while the other device and its associated network provider act as the anchor. It is further contemplated that during the course of a “call” that more than one client-based multimode handover process are performed using either device and its associated network provider as the anchoring point as needed.

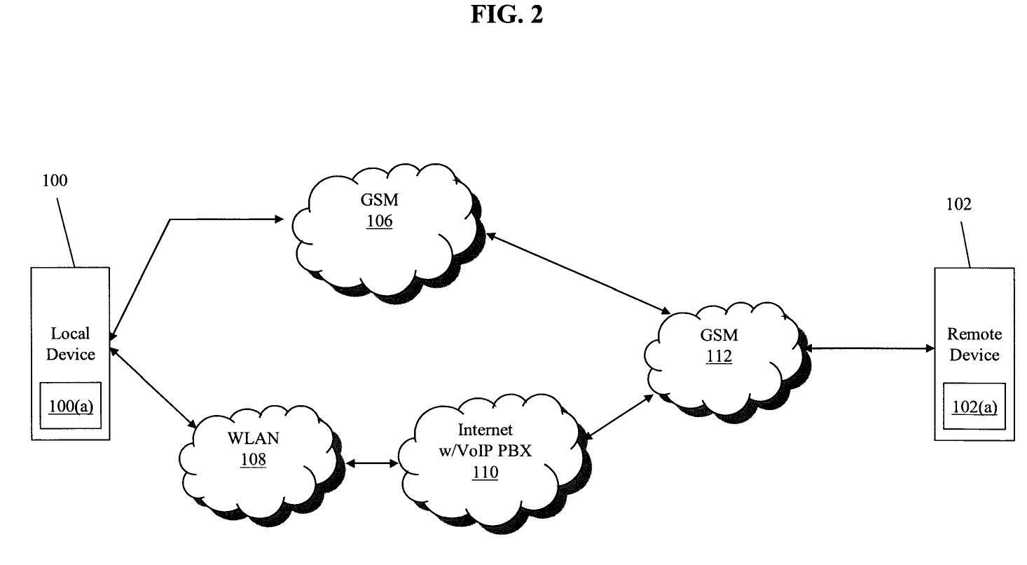

FIGS. 2-10 provide additional examples of network topologies in which client-based multimode handover process may be implemented. For the sake of brevity and clarity, description of elements identified by like reference numerals are not repeated.

FIG. 2 is a network diagram of an exemplary environment in which the client-based multimode handover process may operate. In FIG. 2, local device 100 is a GSM phone having multiple radio transceivers and is able to connect to multiple networks such as GSM network 106 and WLAN 108 connected to Internet 110 having a VoIP Private Branch Exchange (VoIP PBX). The VoIP PBX enables local device 100 to make a call to remote device 102 utilizing VoIP via WLAN 108. As shown in FIG. 2, remote device 102 includes a GSM phone, but is only a single-mode communication device. As stated above, remote device 102 may be a single-mode or multimode communication device. Remote device 102 communicates with local device 100 via remote device's network/service provider, which operates a second GSM network 112. As described above, local device 100 includes a handover engine module 100(a) and remote device 102 includes a handover anchor module 102(a). Thus, employing the client-based multimode handover process, local device 100 utilizes the combination of remote device 102 and its GSM network 112 as an anchor to handover the call from GSM network 106 to WLAN 108/Internet 110, or vice versa, in order to maintain call continuity.

Although, GSM network 106 and GSM network 112 are shown in FIG. 2 as two separate GSM networks, it is within the scope of this disclosure that these two GSM networks are the same network. Accordingly, local device 100 and remote device 102 can be connected to the same GSM network or to two separate GSM networks when utilizing the client-based multimode handover process.

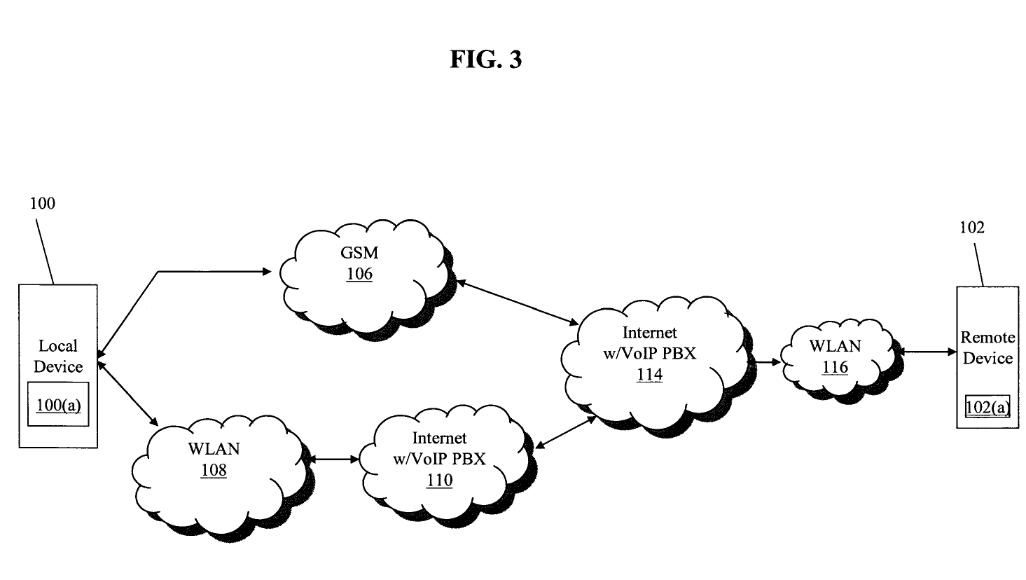

FIG. 3 is a network diagram of an exemplary environment in which the client-based multimode handover process may operate. In FIG. 3, remote device 102 includes a VoIP phone such as a session initiated protocol (SIP) phone. Remote device 102 and local device 100 communicate via a WLAN 116 that is connected to Internet 114 having a VoIP PBX. As described above, local device 100 includes a handover engine module 100(a) and remote device 102 includes a handover anchor module 102(a). Thus, employing the client-based multimode handover process, local device 100 utilizes the combination of remote device 102 and WLAN 116/Internet 114 as an anchor to handover a call from GSM network 106 to WLAN 108/Internet 110, or vice versa, in order to maintain call continuity.

It should be noted that although Internet 110 and Internet 114 are shown in FIG. 3 as two separate Internet networks, it is within the scope of this disclosure that these two Internet networks are the same Internet network.

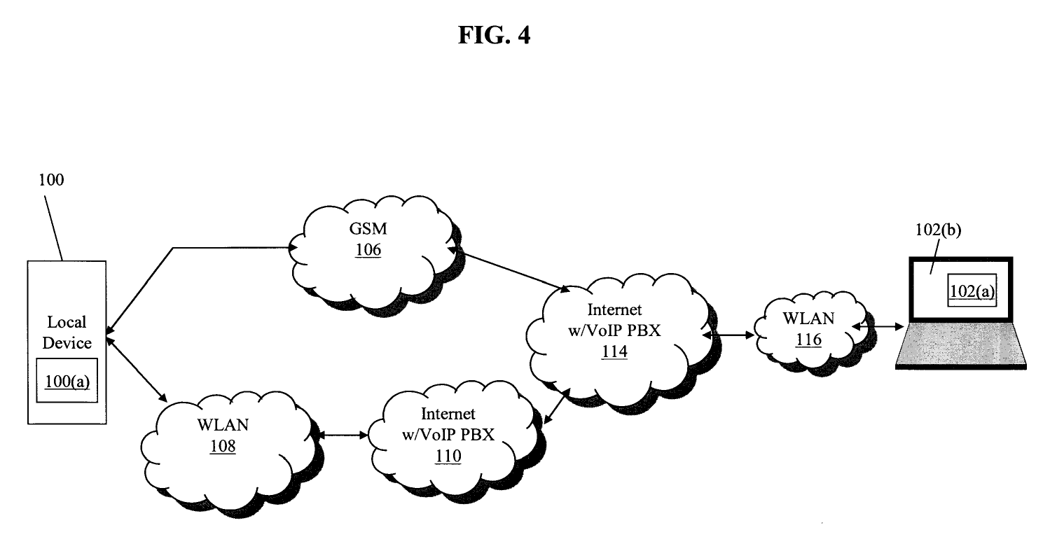

FIG. 4 is a network diagram of an exemplary environment in which the client-based multimode handover process may operate. FIG. 4 is similar to FIG. 3 except that remote device is a computer 102(b) such as a laptop, desktop, or netbook. Remote device 102(b) may be a multimode computer with VoIP capabilities harnessed through multiple network cards (e.g., 802.11 WLAN card, wired Ethernet card, and 3G interface). As described above, local device 100 includes a handover engine module 100(a) and remote device (e.g., computer 102(b)) includes a handover anchor module 102(a). Thus, employing the client-based multimode handover process, local device 100 utilizes the combination of remote device 102(b) and WLAN 116/Internet 114 as an anchor to handover a call from GSM network 106 to WLAN 108/Internet 110, or vice versa, in order to maintain call continuity.

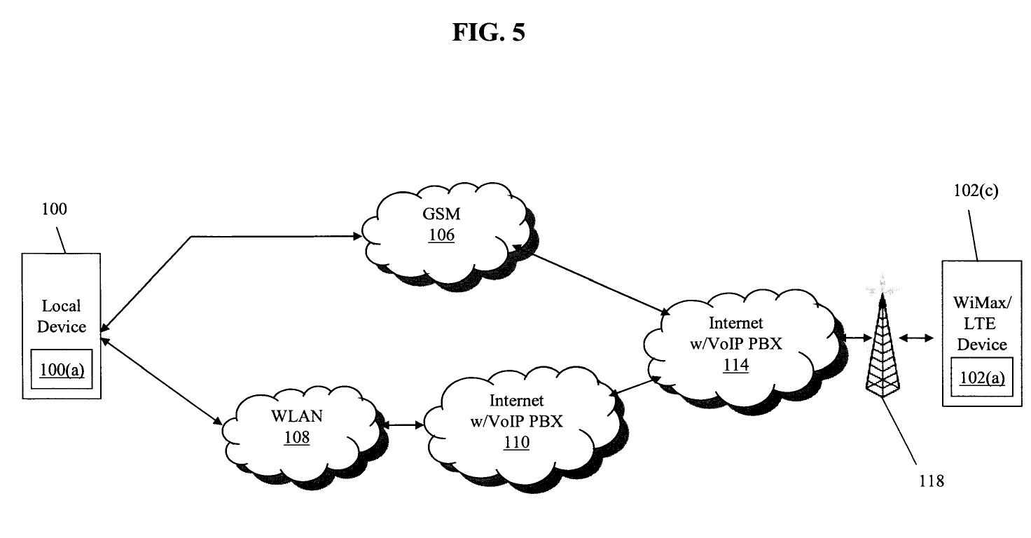

FIG. 5 is a network diagram of an exemplary environment in which the client-based multimode handover process may operate. In FIG. 5, remote device 102(c) is a Worldwide Interoperability for Microwave Access (WiMAX) or Long Term Evolution (LTE) capable device. Remote device 102(c) is coupled to a communication tower 118 which is coupled to Internet network 114. As described above, local device 100 includes a handover engine module 100(a) and remote device (e.g., WiMAX/LTE device 102(c)) includes a handover anchor module 102(a). Employing the client-based multimode handover process, local device 100 utilizes the combination of remote device 102(c) and communication tower 118/Internet 114 as an anchor to handover a call from GSM network 106 to WLAN 108/Internet 110, or vice versa, in order to maintain call continuity. It should be noted that remote device 102(c) in FIG. 5 can also be a multimode device having VoIP and/or GSM capabilities.

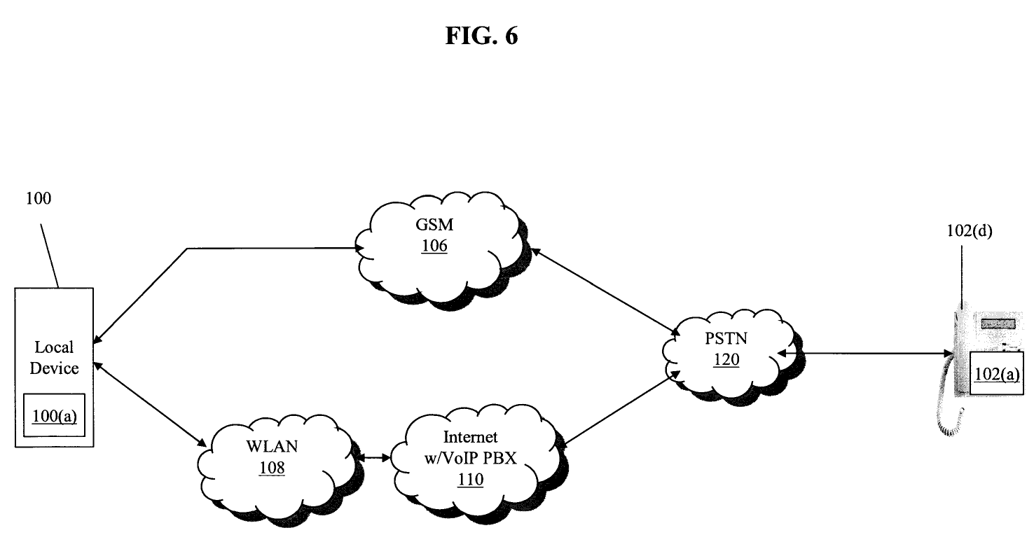

FIG. 6 is a network diagram of an exemplary environment in which the client-based multimode handover process may operate. In FIG. 6, remote device 102(d) includes a standard wired telephone connected to PSTN 120. This design can also be implemented with remote device 102(d) being a VoIP based phone with VoIP capabilities. As described above, local device 100 includes a handover engine module 100(a) and remote device (e.g., standard wired telephone 102(d)) includes a handover anchor module 102(a). Thus, employing the client-based multimode handover process, local device 100 utilizes the combination of remote device 102(d) and PSTN 120 as an anchor to handover a call from GSM network 106 to WLAN 108/Internet 110, or vice versa, in order to maintain call continuity.

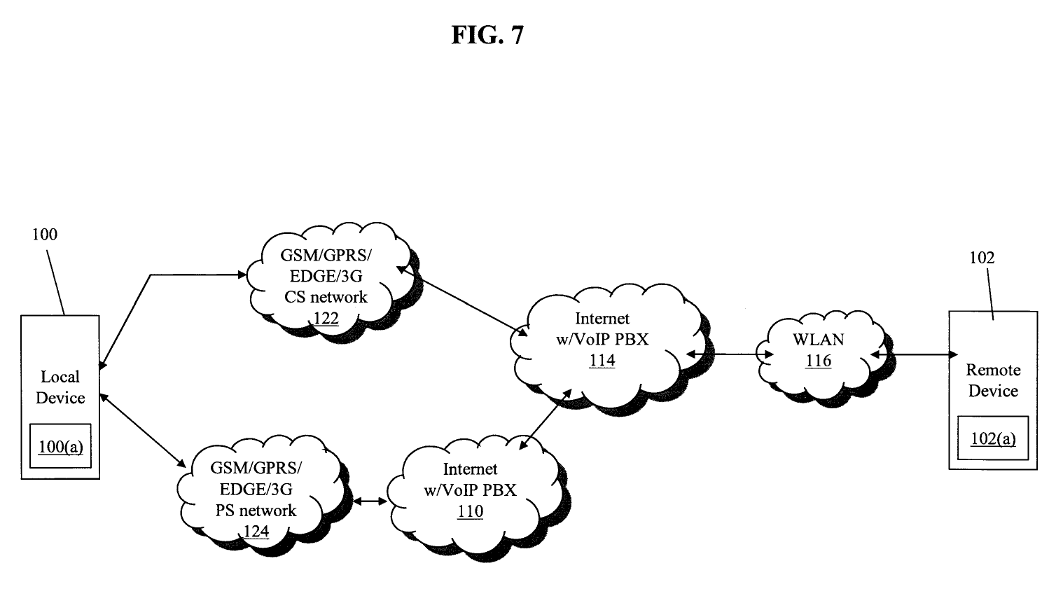

FIG. 7 is a network diagram of an exemplary environment in which the client-based multimode handover process may operate. In FIG. 7, local device 100 has multiple radio transceivers and is able to connect to multiple networks, namely, a GSM/GPRS/EDGE/3G Circuit Switch Network 122 and a GSM/GPRS/EDGE/3G Packet Switch Network 124. Connecting via these networks enables local device 100 to make a call to remote device 102 via either the circuit-switched or packet-switched network. Remote device 102 in FIG. 7 can be any exemplary remote device discussed above. As described above, local device 100 includes a handover engine module 100(a) and remote device 102 includes a handover anchor module 102(a). Thus, employing the client-based multimode handover process, local device 100 utilizes the combination of remote device 102 and WLAN 116/Internet 114 as an anchor to handover a call from GSM/GPRS/EDGE/3G Circuit Switch Network 122 to GSM/GPRS/EDGE/3G Packet Switch Network 124, or vice versa, in order to maintain call continuity.

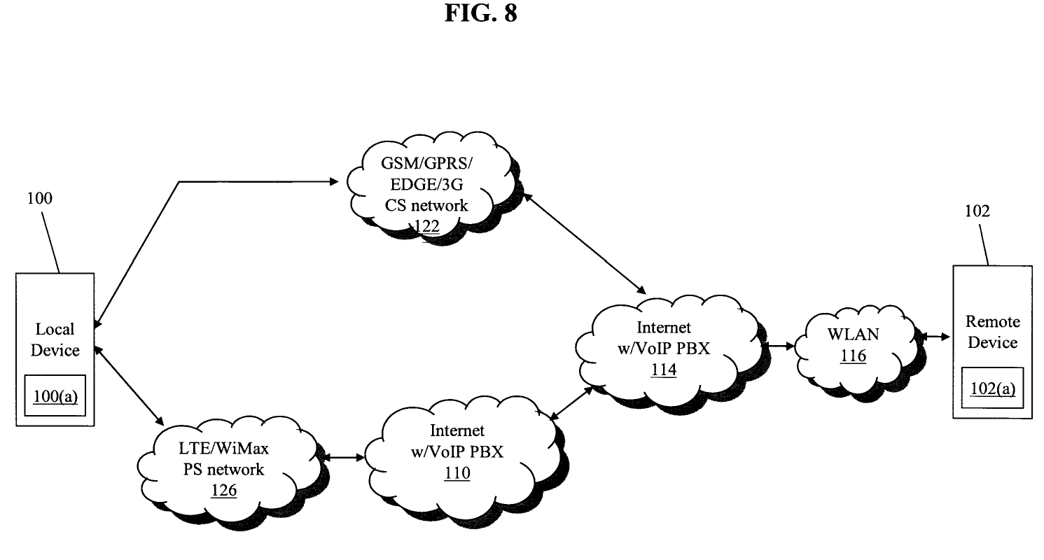

FIG. 8 is a network diagram of an exemplary environment in which the client-based multimode handover process may operate. FIG. 8 is similar to FIG. 7 except GSM/GPRS/EDGE/3G Packet Switch Network 124 has been replaced by a LTE or WiMax Packet Switch Network 126. Again, local device 100 has the capability to connect to different circuit-switched and packet-switched networks. As described above, local device 100 includes a handover engine module 100(a) and remote device 102 includes a handover anchor module 102(a). Employing the client-based multimode handover process, local device 100 utilizes the combination of remote device 102 and WLAN 116/Internet 114 as an anchor to handover a call from LTE or WiMax Packet Switch Network 126 to GSM/GPRS/EDGE/3G Circuit Switch Network 122, or vice versa, in order to maintain call continuity.

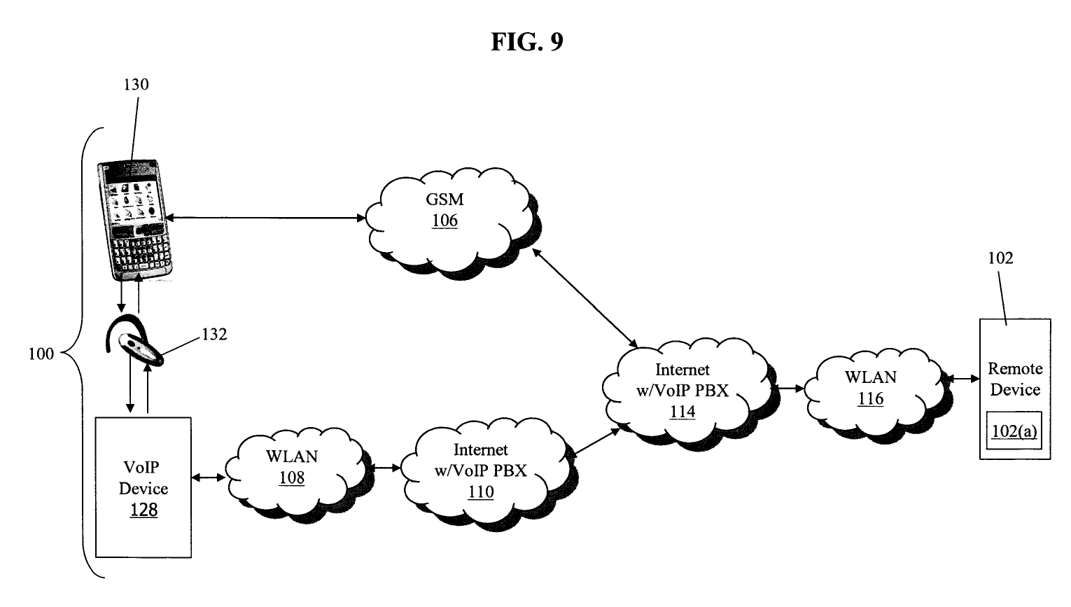

FIG. 9 is a network diagram of an exemplary environment in which the client-based multimode handover process may operate. In FIG. 9, local device 100 includes a combination of a VoIP devices and a GSM capable device. VoIP device 128 may be a VoIP program executing on a computer, for example. GSM capable device 130 may be a residential wired phone and/or cellular phone. The communication between the parts of local device 100 may be via a Bluetooth device 132, which maintains a seamless connection between VoIP device 128 and GSM capable device 130. As described above, local device 100 includes a handover engine module 100(a) and remote device 102 includes a handover anchor module 102(a). Thus, employing the client-based multimode handover process, local device 100, as a combination of multiple devices, utilizes the combination of remote device 102 and WLAN 116/Internet 114 as an anchor to handover a call from GSM network 106 to WLAN 108/Internet 110, or vice versa, in order to maintain call continuity.

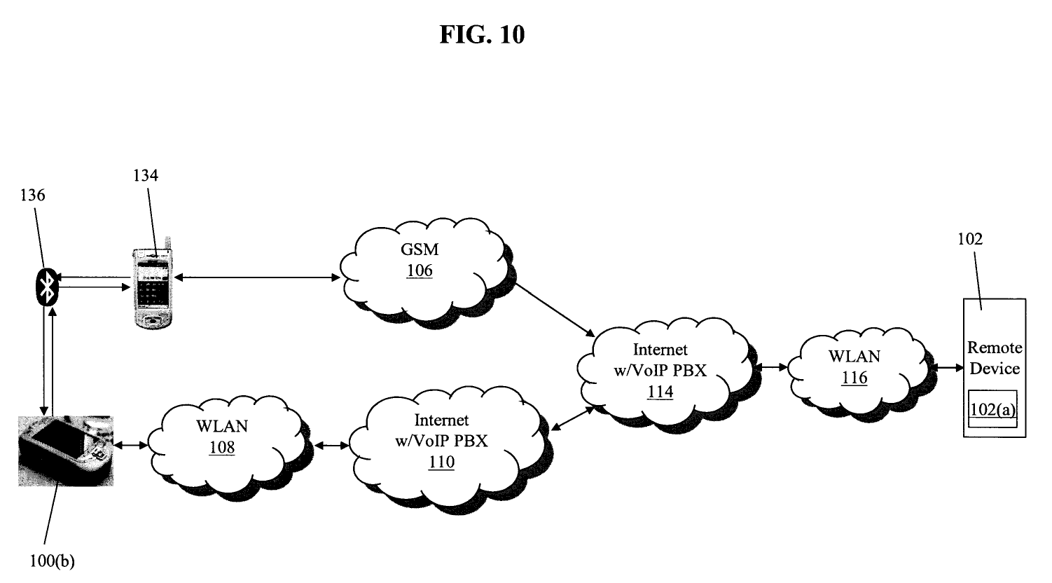

FIG. 10 is a network diagram of an exemplary environment in which the client-based multimode handover process may operate. In FIG. 10, local device 100 includes a single-mode communication device such as PDA 100(b) with WiFi capability that enables PDA 100(b) to connect to Internet 110 via WLAN 108. However, in this scenario PDA 100(b) has the additional ability to connect to cellular device 134 via a Bluetooth connection 136. Thus, via Bluetooth connection 136, PDA 100(b) has access to GSM network 106. As described above, local device 100 includes a handover engine module 100(a) and remote device 102 includes a handover anchor module 102(a). Therefore, even though PDA 100(b) is a single-mode communication device, employing the client-based multimode handover process, PDA 100(b) utilizes the combination of remote device 102 and WLAN 116/Internet 114 as an anchor to handover a call from GSM network 106 to WLAN 108/Internet 110, or vice versa, in order to maintain call continuity.

Alternatively, PDA 100(b) may have access to two different networks via only Bluetooth connection 136 to cellular device 134. For example, cellular device 134 can be a multimode communication device that has access to both a circuit-switched and packet-switched network. Therefore, connecting PDA 100(b) via Bluetooth connection 136 to cellular device 134 indirectly provides PDA 100(b) the access to both a circuit-switched and packet-switched network. Therefore, even though PDA 100(b) is a single-mode communication device, employing client-based multimode handover process, PDA 100(b) utilizes the combination of remote device 102 and WLAN 116/Internet 114 as an anchor to handover a call from a circuit-switched network to a packet-switched network via cellular device 134, or vice versa, in order to maintain call continuity.

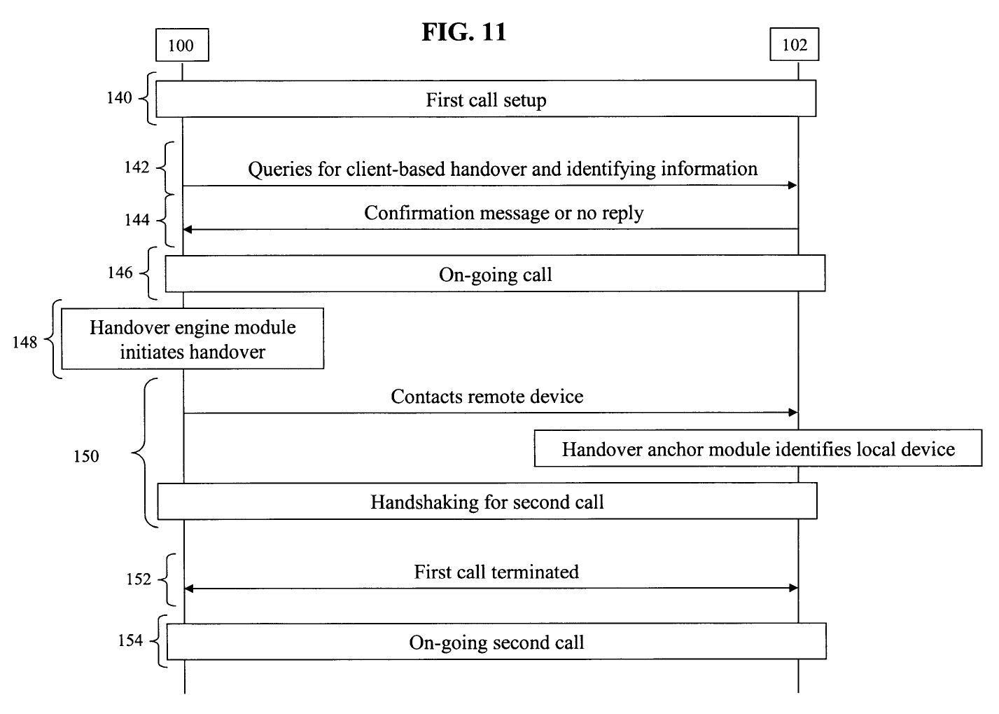

FIG. 11 is a data flow diagram of an exemplary embodiment of the client-based multimode handover process occurring between local device 100 and remote device 102. At step 140, a first call is established between local device 100 and remote device 102. Either device 100 or device 102 may originate the call. The call established during step 140 occurs across a first network connection accessible by local device 100. As discussed previously, a call may include, but is not limited to voice, email, data, video, messaging, file transfer, and web sessions between local device 100 and remote device 102.

During the handshaking process that occurs while the call is being setup, local device 100 at step 142, sends a query to remote device 102 inquiring whether remote device 102 supports client-based multimode handover. The query involves utilizing commonly known communication protocols that enable local device 100 to send data to remote device 102. Communication protocols that enable local device 100 to send data such as a message include, but are not limited to short message service (SMS), Internet protocol (IP), Internet protocol version 6 (IPv6), Internet protocol security (IPSec), H.323 recommendation from the ITU Telecommunication Standardization Sector (ITU-T), multi-protocol label switching (MPLS), transmission control protocol/Internet protocol (TCP/IP), user datagram protocol (UDP), media gateway control protocol (MGCP), real time transport protocol (RTP), instant messaging (IM), or session initiation protocol (SIP). Thus, it is contemplated that any communication protocol that allows the transmission of data, such as for messaging purposes, may be used for any handshaking activities that may occur between local device 100 and remote device 102.

Additionally, at step 142 local device 100 sends the identifying information of connectivity for its radio transceivers, network providers, and/or service providers to remote device 102. Furthermore, the identifying information may include, but is not limited to caller identification, information identifying local device's first communication network connection, and information identifying local device's second communication network connection. Local device 100 sends this identifying information, so that remote device 102 can recognize a second call from local device 100 during the handover process. Furthermore, during this step local device 100 alerts remote device 102 which of the identifying information represents the current network connection being used for the first call.

At step 144, remote device 102 either (i) replies with a message confirming that remote device 102 supports client-based multimode handover or (ii) does not reply to the query from local device 100. In the event, that remote device 102 does not reply to the query, local device 100 interprets the non-reply as an indication that remote device 102 is not capable of supporting client-based multimode handover.

At step 146, handshaking for the first call is completed between local device 100 and remote device 102, and the first call is ongoing. At some point, handover engine module 100(a) of local device 100 may decide to handover the call from its first network connection to it second network connection. At step 148, the client-based handover process is initiated by handover engine module 100(a) residing within local device 100.

The decision of the handover made by local device 100 may be based on any number of factors. For example, local device 100 may decide to perform the handover because the signal strength of the second network connection is higher than the current network connection. Likewise, local device 100 may decide to switch to the second network connection when the quality of communication across the first network has degraded. Additionally, local device 100 may base its handover decision on the comparative link statistics of the two networks. Furthermore, handover engine module 100(a) may base its decision to initiate a handover based on the comparative costs of the two network connections, higher data transfer rates across one of the network connections, applications running on local device 100 and/or remote device 102, and/or the remaining battery power of local device 100 and/or remote device 102.

Although local device 100 is responsible for the handover decision, its decision may further be influenced by the preferences of remote device 102. For example, during the initial handshake occurring at step 144, remote device 102 may send its connection preferences to local device 100. Preferences transmitted by remote device 102 may include, but not limited to that it has lower costs associated with certain types of networks or that it receives incoming calls for free. The degree to which local device 100 considers remote device's preferences may be determined by the handover decision settings programmed within handover engine module 100(a).

Additional factors that may be consider by handover engine module 100(a) for determining whether to initiate a handover include considering the time of day, day of week, subscription plan of local device 100, subscription plan of remote device 102, cost associated with the first communication network in comparison to cost associated with the second communication network for local device 100, cost associated with the first communication network in comparison to cost associated with the second communication network for remote device 102, and user defined preferences from either local device 100 and/or remote device 102 for communication connectivity.

The preferences and factors discussed above are intended to be examples of criteria that are considered by handover engine module 100(a) of local device 100. Furthermore, additional handover criteria can be found in related co-pending U.S. patent application Ser. No. 11/929,231, filed Oct. 30, 2007, entitled “System, Method, and Computer-Readable Medium for User Equipment Decision-Making Criteria for Connectivity and Handover,” and to U.S. patent application Ser. No. 11/929,066, filed Oct. 30, 2007, entitled “System, Method, and Computer-Readable Medium for Selecting a Network for Connectivity and Handover Based on Application Requirements,” the disclosures of which are incorporated by reference.

At step 150, local device 100 contacts remote device 102 requesting a handover, via its second network connection, different from the first network connection currently in use for the first call. Specifically, local device 100 contacts remote device 102 using two alternative options described below.

The first option involves local device 100 calling remote device 102 via the second network in order to establish the second call. Under the first option, handover anchor module 102(a) residing in remote device 102 determines the identity of the second incoming call as being from local device 100 by either using caller identification or via an explicit message sent by local device 100 accompanying the call setup process of the second call. All communication protocols discussed above may be used to send the explicit message. Specifically, communication protocols that enable local device 100 to send data such as a message to remote device 102 include, but are not limited to SMS, IP, IPv6,IPSec, H.323 recommendation from the ITU Telecommunication Standardization Sector, MPLS, TCP/IP, UDP, MGCP, RTP, IM, SIP, and caller-ID. Thus, it is contemplated that any communication protocol that allows the transmission of data, such as for messaging purposes, may be used for any handshaking activities that may occur between local device 100 and remote device 102.

Handover anchor module 102(a) of remote device 102 uses the data supplied by local device 100 to determine that the second call is coming from local device 100 and implements the client-based multimode handover process. In response to remote device 102 recognizing that the second call is from local device 100, handover anchor module 102(a) of remote device 102 may be programmed to automatically answer the second call or require user input by prompting the user to either accept or decline the second call.

The second options involves local device 100 establishing the second call with remote device 102 by first sending remote device 102 a message in step 150. In this scenario, local device 100 sends remote device 102 a message with the identifying information of its second network connection. Because local device 100 previously sent the second network identifying information to remote device 102 in step 142, handover anchor module 102(a) residing of remote device 102 recognizes that the message is from local device 100. Subsequently, handover anchor module 102(a) implements the client-based multimode handover process by calling local device 100 on its second network connection to establish the second call. It should be noted that handover anchor module 102(a) may be programmed to automatically call local device 102 upon receiving local device's message requesting a handover, or remote device 102 may be setup to require user input by prompting the user to approve the second call.

While the handshaking with respect to the second call occurs, the call flow as seen in FIG. 11 proceeds to step 152. In step 152, the first call between local device 100 and remote device 102 is terminated. The termination of the first call can be initiated by either local device 100 or remote device 102. However, local device 100 and remote device 102 have to decide whether to establish the second call before terminating the first call or terminate the first call before establishing the second call. By establish the second call before terminating the first call, local device 100 and remote device 102 can maintain call continuity during the client-based handover process.

In order to establish the second call before terminating the first call, local device 100 can take advantage of traditional calling features associated with remote device 102 that enable remote device to be able to handle multiple calls and/or calling devices simultaneously. For example, remote device 102 can utilize call waiting, multiparty calling, and conference calling capabilities to enable remote device 102 to handle multiple simultaneous calls and/or calling devices.

Specifically with respect to conference calling, remote device 102 may be able to utilize traditional PSTN conferencing or VoIP conference calling service. In that regard, remote device 102 may implement the following procedures to handle multiple simultaneous calls and/or calling devices. First, remote device 102 creates a conference call and adds, for example, the first call with local device 100 to the conference. Secondly, remote device 102 can add additional calls it receives to the established conference call including the second call established with local device 100. Third, remote device 102 has the ability as the conference call leader to remove the first call with local device 100 from the conference call, thereby leaving the second call with local device 100 as the only participant in the conference call. Finally, remote device 102 can terminate the conference call when all calls with local device 100 are terminated. Therefore, as an example, remote device 102 can take advantage of already established calling features, such as conference calling, in order to handle multiple simultaneous calls and/or calling devices.

Regardless of whether local device 100 or remote device 102 initiates termination, the first call is terminated during step 152. Upon termination of the first call, the client-based handover process is completed between local device 100 and remote device 102. Therefore, local device 100 has used the combination of remote device 102 and its associated network provider as a call anchoring point to switch the first call made originally on local device's first network connection onto local device's second network connection trough the use of the second call.

Finally, the call flow proceeds to step 154 where local device 100 and remote device 102 are in communication with one another through the established second call. The established second call utilizes the second network connection accessible to local device 100. Thus, through call flow process outlined in FIG. 11 local device 100 is capable of switching calls across its network connections by using the combination of remote device 102 and its network provider as an anchoring point, while maintaining call continuity with remote device 102, and without relying on the network provider having implemented an IMS-converged network.

It should be noted that the call flow disclosed in FIG. 11 is not intended to be limiting or exhaustive in the possible variations that would occur to one skilled in the art. Furthermore, the call flow is not limited to a single pass through the various steps outlined above. Instead, parts or all of the call flow may be iterative. In fact, local device 100 can use the above call flow to switch the second call back to local device's first network connection or even to a third network connection that is accessible by local device 100. In other words, there is no implied or inherent limitation in the above described call flow process for client-based multimode handover in the number of occurrences a call can be switched from one network to another network or on the number of networks that local device 100 can use to switch calls.

While embodiments of the invention have been illustrated and described in detail in the disclosure, the disclosure is to be considered as illustrative and not restrictive in character. All changes and modifications that come within the spirit of the invention are to be considered within the scope of the disclosure.

The foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A communication system comprising:
a first communication device being in communication with a second communication device via a communication connectivity to a first communication network, the first communication device having a first handover module operable to handover communication connectivity from the first communication network to a second communication network; and
the second communication device having a second handover module cooperatively operable with the first handover module to maintain communication between the second communication device and the first communication device while the first handover module operates to handover communication connectivity from the first communication network to the second communication network.

2. The communication system of claim 1, wherein the first communication device is selected from a group consisting at least one of a soft phone on a personal computer, cell phone, session initiated protocol (SIP) phone, a voice over Internet protocol (VoIP) phone, Bluetooth device enabled to communicate with a phone, personal digital assistant, WiFi enabled phone device, and a phone operable with a public switched telephone network (PSTN).

3. The communication system of claim 1, wherein the second communication device is selected from a group consisting at least one of a soft phone on a personal computer, cell phone, session initiation protocol (SIP) phone, a voice over Internet protocol (VoIP) phone, Bluetooth device enabled to communicate with a phone, personal digital assistant, WiFi enabled phone device, and a traditional public switched telephone network (PSTN).

4. The communication system of claim 1, wherein the first and second communication network is each selected from a group of networks consisting of WiFi, Internet Protocol (IP), code division multiple access (CDMA), global system for mobile communications (GSM), voice over Internet protocol (VoIP), public switching telephone network (PSTN), worldwide interoperability for microwave access (WiMAX), long term evolution (LTE), third generation (3G), GPRS operating over EDGE (EGPRS), and any other packet-switched and/or circuit-switched network.

5. The communication system of claim 1, wherein the communication connectivity to the first communication network is wireless.

6. The communication system of claim 1, wherein the first handover module initiates the handover of the communication connectivity from the first communication network to a second communication network by sending a message to the second handover module.

7. The communication system of claim 6, wherein the message is transmitted via a protocol selected from a group consisting of short message service (SMS), instant messaging (IM), and session initiation protocol (SIP).

8. The communication system of claim 6, wherein the message comprises an identity information of the first communication device used by the second handover module to verify the first communication device and enable the handover of communication connectivity from the first communication network to the second communication network.

9. The communication system of claim 8, wherein the identity information is selected from a group consisting of caller identification, information identifying the first communication network connection, and information identifying the second communication network connection.

10. The communication system of claim 1, wherein the first handover module comprises a decision logic to handover communication connectivity from the first communication network to the second communication network based on at least one factor selected from the group consisting of time of day, day of week, subscription plan of the first communication device, subscription plan of the second communication device, cost associated with the first communication network in comparison to cost associated with the second communication network for the first communication device, cost associated with the first communication network in comparison to cost associated with the second communication network for the second communication device, user preferences for communication connectivity, relative signal strength of the first network compared to the relative signal strength of the second network connection for the first communication device, relative signal strength of the first network compared to the relative signal strength of the second network connection for the second communication device, degradation of a first quality of the first communication network, degradation of a second quality of the second communication network, comparative link statistics of the two networks, data transfer rate of one of the first and second communication networks, applications running on the first communication device, applications running on the second communication device, battery power of one of the first and second communication devices, preferences of the first communication device, and preferences of the second communication device.

11. The communication system of claim 1, wherein one of the first and second handover modules terminates the communication connectivity to the first communication network after the handover.

12. The communication system of claim 1, wherein one of the first and second handover modules terminates the communication connectivity to the first communication network before the handover.

13. A method of handover comprising:
establishing a first communication path between a local communication device and a remote communication device via a first network connection of the local communication device;
communicating a first message having an identity information from the local communication device to the remote communication device via the first communication path, wherein the remote communication device confirms receipt of the identity information;
forming a second network connection at the local communication device and sending a second message having the identity information via the second network connection to the remote communication device;
establishing a second communication path between the local communication device and the remote communication device via the second network connection at the local communication device in response to receiving the second message; and
terminating the first communication path.

14. The method of claim 13, wherein communicating a first message and a second message having an identity information comprises sending information selected from a group consisting of caller identification, information identifying the first communication network connection, and information identifying the second communication network connection.

15. The method of claim 13, wherein communicating a first message further comprises querying to determine whether the remote communication device supports handover.

16. The method of claim 15, wherein sending a second message comprises data associated with maintaining the first communication path while the second communication path is being established.

17. The method of claim 13, wherein sending a second message further comprises verifying the identity information of the second message against the identity information of the first message to confirm the second message was communicated from the local communication device.

18. The method of claim 13, further comprising terminating the first communication path after establishing the second communication path.

19. The method of claim 13, further comprising terminating the first communication path before establishing the second communication path.

20. The method of claim 13, further comprising determining whether a handover should be performed.

21. The method of claim 20, wherein determining whether the handover should be performed comprises considering at least one factor selected from the group consisting of time of day, day of week, subscription plan of the first communication device, subscription plan of the second communication device, cost associated with the first communication network in comparison to cost associated with the second communication network for the first communication device, cost associated with the first communication network in comparison to cost associated with the second communication network for the second communication device, user preferences for communication connectivity, relative signal strength of the first network compared to the relative signal strength of the second network connection for the first communication device, relative signal strength of the first network compared to the relative signal strength of the second network connection for the second communication device, degradation of a first quality of the first communication network, degradation of a second quality of the second communication network, comparative link statistics of the two networks, data transfer rate of one of the first and second communication networks, applications running on the first communication device, applications running on the second communication device, battery power of one of the first and second communication devices, preferences of the first communication device, and preferences of the second communication device.

22. A method for a client-based handover process comprising:
establishing a first communication path between a local communication device and a remote communication device via a first network connection of the local communication device;
sending, by the local communication device, a first message having an identifying information of the first communication device across the first network connection to the remote communication device;
determining, by the local communication device, to form a second communication path between the local communication device and the remote communication device by utilizing a second network connection of the local communication device;
sending, by the local communication device, a second message having the identifying information across the second network connection of the local communication device;
establishing the second communication path between the local communication device and the remote communication device via the second network connection of the local communication device; and
terminating the first communication path.

23. A method for a client-based handover process comprising:
establishing a first communication path between a remote communication device and a local communication device via a first network connection of the local communication device;
receiving, by the remote communication device, a first message having an identifying information of the first communication device, the first message being received from the first network connection;
receiving, by the remote communication device, a second message having the identifying information, the second message being received from the second network connection;
establishing a second communication path between the local communication device and the remote communication device utilizing the second network connection of the local communication device; and
terminating the first communication path.
